(19) United States
(12) Patent Application Publication
(10) Pub. No.: US 2023/0385853 A1
(43) Pub. Date: Nov. 30, 2023

(54) INFORMATION PROVIDING SYSTEM, INFORMATION PROVIDING METHOD, AND NON-TRANSITORY STORAGE MEDIUM

(71) Applicant: NEC Corporation, Minato-ku, Tokyo (JP)

(72) Inventors: Emiko ISHII, Tokyo (JP); Hanae Shimomura, Tokyo (JP); Shingo Chiyondbu, Tokyo (JP); Hiroki Seto, Tokyo (JP)

(73) Assignee: NEC Corporation, Minato-ku, Tokyo (JP)

(21) Appl. No.: 18/030,969

(22) PCT Filed: Oct. 4, 2021
(86) PCT No.: PCT/JP2021/036550

§ 371 Date: Apr. 7, 2023

(30) Foreign Application Priority Data
Oct. 15, 2020 (JP) 2020-173969

(51) Int. Cl. G06Q 30/0201

(52) U.S. Cl. CPC G06Q 30/0201

(57) ABSTRACT

The present invention provides an information providing system (10) including a counterpart face image registration unit (11) that acquires a counterpart face image being a face image of a counterpart who is a target of investigation by a user, and registers the counterpart face image in association with user discrimination information of the user, an information generation unit (12) that detects, based on the counterpart face image, the counterpart from an in-store image capturing inside of a store, determines, based on a behavior content of the detected counterpart inside a store indicated in the in-store image, a product in which the counterpart shows interest, and registers product information of the determined product in association with the user discrimination information, and a provision unit (14) that provides the user with product information, registered in association with the user discrimination information, of a product in which the counterpart shows interest.

### TECHNICAL FIELD

The present invention relates to an information providing system, an information providing method, and a program.

### BACKGROUND ART

Patent Document 1 discloses a technique for tracking a behavior of a customer with respect to a product, and outputting, to the customer, promotion information being related to the product relevant to the tracked behavior of the customer. Patent Document 2 discloses a technique for determining a companion of a user by an image analysis, and recommending, to the user, a product that matches clothing of the determined companion.

[Related Document]

[Patent Document]
[Patent Document 1] International Publication No. 2015/033575
[Patent Document 2] Japanese Patent Application Publication No. 2016-57940

### DISCLOSURE OF THE INVENTION

### Technical Problem

It becomes possible to present a product that pleases a counterpart, when what product the counterpart to whom a present is desired to be given has interest in can be recognized. In a case where a counterpart is directly asked about a product in which he/she is interested in, there is a possibility that surprise or joy of the counterpart at a time when the product is presented lessens. Hence, a technique for recognizing a product in which a counterpart has interest, in such a way that the counterpart does not notice, is desired. Neither Patent Document 1 nor 2 discloses the problem and a means for solving the problem.

The present invention provides a technique for recognizing a product in which a counterpart has interest, in such a way that the counterpart does not notice.

### Solution to Problem

The present invention provides an information providing system including:

a counterpart face image registration unit that acquires a counterpart face image being a face image of a counterpart who is a target of investigation by a user, and registers the counterpart face image in association with user discrimination information of the user;

an information generation unit for detects, based on the counterpart face image, the counterpart from an in-store image capturing inside of a store, determines, based on a behavior content of the detected counterpart inside a store indicated in the in-store image, a product in which the counterpart shows interest, and registers product information of the determined product in association with the user discrimination information; and

a provision unit that provides the user with product information, registered in association with the user discrimination information, of a product in which the counterpart shows interest.

Moreover, the present invention provides an information providing method including, by a computer:
acquiring a counterpart face image being a face image of a counterpart who is a target of investigation by a user, and registering the counterpart face image in association with user discrimination information of the user;
detecting, based on the counterpart face image, the counterpart from an in-store image capturing inside of a store, determining, based on a behavior content of the detected counterpart inside a store indicated in the in-store image, a product in which the counterpart shows interest, and registering product information of the determined product in association with the user discrimination information; and
providing the user with product information, registered in association with the user discrimination information, of a product in which the counterpart shows interest.

Moreover, the present invention provides a program causing a computer to function as:
a counterpart face image registration unit that acquires a counterpart face image being a face image of a counterpart who is a target of investigation by a user, and registers the counterpart face image in association with user discrimination information of the user,
an information generation unit that detects, based on the counterpart face image, the counterpart from an in-store image capturing inside of a store, determines, based on a behavior content of the detected counterpart inside a store indicated in the in-store image, a product in which the counterpart shows interest, and registers product information of the determined product in association with the user discrimination information, and
a provision unit that provides the user with product information, registered in association with the user discrimination information, of a product in which the counterpart shows interest.

### Advantageous Effects of Invention

The present invention achieves a technique for recognizing a product in which a counterpart has interest, in such a way that the counterpart does not notice.

### BRIEF DESCRIPTION OF THE DRAWINGS

FIG. 1 is a diagram illustrating one example of a hardware configuration of an information providing system according to the present example embodiment.

FIG. 2 is one example of a functional block diagram of the information providing system according to the present example embodiment.

FIG. 3 is a diagram schematically illustrating one example of information to be processed by the information providing system according to the present example embodiment.

FIG. 4 is a flowchart illustrating one example of a flow of processing in the information providing system according to the present example embodiment.

FIG. 5 is a diagram schematically illustrating one example of information to be processed by the information providing system according to the present example embodiment.

FIG. 6 is a flowchart illustrating one example of a flow of processing in the information providing system according to the present example embodiment.

FIG. 7 is a diagram schematically illustrating one example of information to be processed by the information providing system according to the present example embodiment.

### DESCRIPTION OF EMBODIMENTS

Hereinafter, an example embodiment of the present invention is described by use of the drawings. Note that, in all of the drawings, a similar component is assigned with a similar reference sign, and description thereof is omitted, as appropriate.

### First Example Embodiment

### “Outline”

An outline of processing in an information providing system according to the present example embodiment is as follows. First, a user registers, in the information providing system, a face image (counterpart face image) of a counterpart who is a target of investigation. The information providing system detects, based on the counterpart face image, the counterpart from an in-store image capturing inside of a store. Then, the information providing system determines, based on a behavior content of the counterpart inside the store indicated in the in-store image, a product in which the counterpart shows interest, and registers product information of the determined product in association with user discrimination information of the user. Then, the information providing system provides the user with the “product information of the product in which the counterpart shows interest” registered in association with the user discrimination information of the user.

According to such an information providing system, a user can recognize a product in which a counterpart has interest, in such a way that the counterpart does not notice.

### “Configuration”

Next, a configuration of the information providing system is described. The information providing system may be a cloud server, may be a store server installed in each store, may be a center server installed in a center that manages a plurality of stores, or may be any other system.

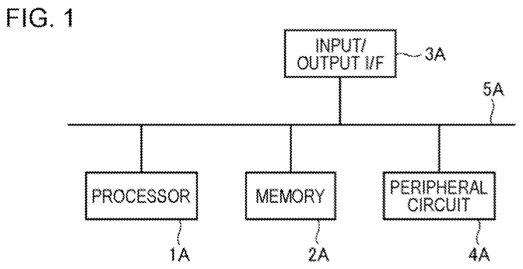

First, one example of a hardware configuration of the information providing system is described. FIG. 1 is a diagram illustrating a hardware configuration example of the information providing system. Each functional unit included in the information providing system is achieved by any combination of hardware and software mainly including a central processing unit (CPU) of any computer, a memory, a program loaded onto the memory, a storage unit such as a hard disk that stores the program (that can store not only a program previously stored from a phase of shipping an apparatus but also a program downloaded from a storage medium such as a compact disc (CD), a server on the Internet, and the like), and an interface for network connection. Then, it is appreciated by a person skilled in the art that there are a variety of modified examples of a method and an apparatus for the achievement.

As illustrated in FIG. 1, the information providing system includes a processor 1A, a memory 2A, an input/output interface 3A, a peripheral circuit 4A, and a bus 5A. The peripheral circuit 4A includes various modules. The information providing system may not include the peripheral circuit 4A.

Note that, the information providing system may be configured by a plurality of physically and/or logically separated apparatuses, or may be configured by one physically and logically integrated apparatus. In the former case, each of the apparatuses can include the hardware configuration described above.

The bus 5A is a data transmission path for the processor 1A, the memory 2A, the peripheral circuit 4A, and the input/output interface 3A to mutually transmit and receive data. The processor 1A is, for example, an arithmetic processing apparatus such as a CPU and a graphics processing unit (GPU). The memory 2A is, for example, a memory such as a random access memory (RAM) and a read only memory (ROM). The input/output interface 3A includes an interface for acquiring information from an input apparatus, an external apparatus, an external server, an external sensor, and the like, an interface for outputting information to an output apparatus, an external apparatus, an external server, and the like, and the like. The input apparatus is, for example, a keyboard, a mouse, a microphone, and the like. The output apparatus is, for example, a display, a speaker, a printer, a mailer, and the like. The processor 1A can give an instruction to each of modules, and perform an arithmetic operation, based on an arithmetic result of each of the modules.

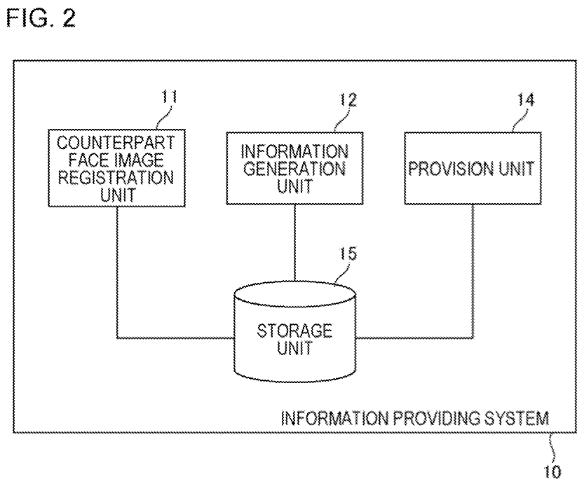

Next, one example of a functional configuration of the information providing system is described. FIG. 2 illustrates one example of a functional block diagram of an information providing system 10. As illustrated, the information providing system 10 includes a counterpart face image registration unit 11, an information generation unit 12, and a provision unit 14. Note that, the information providing system 10 may not include a storage unit 15. In this case, an external apparatus configured to be communicable with the information providing system 10 includes the storage unit 15. Hereinafter, processing achieved by the functional units is described in detail.

The counterpart face image registration unit 11 acquires a counterpart face image being a face image of a counterpart who is a target of investigation by a user, and registers the counterpart face image in association with user discrimination information of the user.

The “user” is a user of an information providing service provided by the information providing system 10 (hereinafter, may be simply referred to as “information providing service”). One can become a user of the information providing service by performing predetermined processing such as membership registration.

The “user discrimination information” is information that discriminates users of the information providing service from each other.

The “investigation” is investigation that determines a product in which a counterpart (a target of investigation) has interest. For example, “a counterpart to whom a user gives a present” or the like is registered as a target of investigation. Note that, the target of investigation may be a user of the information providing service, or may not be a user of the service.

In the present example embodiment, the counterpart face image registration unit 11 acquires a counterpart face image input by a user, and registers the counterpart face image in association with user discrimination information of the user. For example, a user performs an operation of logging in to the information providing system 10 (example: input of user discrimination information or the like) via a predetermined application or a web page. Then, in a counterpart face image registration page after login, the user performs an operation of selecting a counterpart face image stored in a predetermined storage apparatus, and an operation of uploading the selected counterpart face image to the information providing system 10. The user performs the operations via a terminal such as a smartphone, a tablet terminal, a personal computer, a smart watch, or a mobile phone.

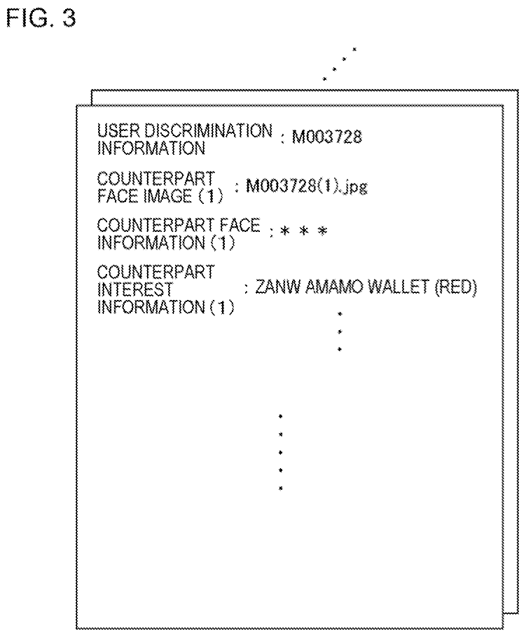

FIG. 3 schematically illustrates one example of information registered by the counterpart face image registration unit 11. The information is stored in the storage unit 15. In the illustrated information, a counterpart face image is registered in association with user discrimination information. In the illustrated information, further, counterpart face information being a feature value of appearance extracted from the counterpart face image is registered in association with the user discrimination information. In this way, the counterpart face image registration unit 11 may extract a feature value of appearance from the counterpart face image, and register the extracted feature value in association with the user discrimination information. Note that, illustrated counterpart interest information is information generated by the information generation unit 12 described later and registered. Details of the counterpart interest information are described later.

Returning to FIG. 2, the information generation unit 12 executes processing of detecting, based on a counterpart face image, a counterpart from an in-store image capturing inside of a store, processing of determining, based on a behavior content of the detected counterpart inside the store indicated in the in-store image, a product in which the counterpart shows interest, and processing of registering product information of the determined product in association with the user discrimination information.

The processing of detecting a counterpart from an in-store image can be achieved by use of any conventional image analysis technique. For example, collation processing of a counterpart face image or a feature value of appearance of a face of a counterpart extracted from the counterpart face image, and an in-store image, or the like is exemplified.

Note that, the information providing system 10 is configured in such a way as to acquire, by any means, an in-store image generated by a camera that captures inside of a store. The in-store image is preferably a moving image, but may be a plurality of time-series still images generated by continuously capturing at a time interval (frame rate) being larger than that of a moving image. The information providing system 10 may acquire the in-store image by batch processing (example: processing data for one day collectively) or may acquire the in-store image by real-time processing. When the in-store image is acquired by batch processing, the processing by the information generation unit 12 is also performed by batch processing. When the in-store image is acquired by real-time processing, the processing by the information generation unit 12 may be performed by real-time processing, or may be performed by batch processing.

The processing of determining a product in which a counterpart shows interest can be achieved by analyzing an in-store image. One example of a method of determining a product in which a counterpart shows interest is described below, but the present invention is not limited to exemplification herein.

### —First Determination Method—

The information generation unit 12 detects, based on an in-store image, a line of sight of a counterpart, and determines a product existing in front of the line of sight. Then, when a state where the product is in front of the line of sight satisfies a predetermined condition (example: continuing for equal to or more than a predetermined time, a cumulative time is equal to or more than a predetermined time), it is determined that the counterpart shows interest in the product.

### —Second Determination Method—

The information generation unit 12 detects, based on an in-store image, a product touched by a counterpart or a product held in a hand, and determines the product as a product in which the counterpart shows interest. Note that, the information generation unit 12 can determine, based on, for example, a feature value of appearance of a product (a product touched by a counterpart or a product held in a hand) included in the image, discrimination information of the product.

### —Third Determination Method—

The information generation unit 12 detects, based on an in-store image, a product that a counterpart has tried, and determines the product as a product in which the counterpart shows interest. An act of trying a product is defined for each product. For example, an act of trying on clothes, an act of sitting on a chair or a sofa, and the like are exemplified. When a trial act defined in relation to each product is performed for each product, the information generation unit 12 determines that the counterpart has tried the product. Note that, when, after an act of trying a product is detected, a predetermined behavior showing interest in the product, such as picking up/seeing, may not be detected, it is considered that the counterpart has tried the product and then lost interest, and the product may not be determined as a product in which the counterpart shows interest. Then, when, after the act of trying the product is detected, the predetermined behavior showing interest in the product, such as picking up/seeing, can be detected, the product may be determined as a product in which the counterpart shows interest.

### —Fourth Determination Method—

The information generation unit 12 determines, based on an in-store image, a position of a counterpart in a store. Then, when a state of existing in front of a display place of a predetermined product satisfies a predetermined condition (example: continuing for equal to or more than a predetermined time, a cumulative time is equal to or more than a predetermined time), the information generation unit 12 determines that the counterpart shows interest in the product.

FIG. 3 schematically illustrates one example of information registered by associating product information of a determined product with user discrimination information. Illustrated “counterpart interest information” indicates product information of the determined product. The product information can include at least one of product discrimination information (product code or the like), a product name, a product image, a manufacturer name, a price, and a product specification. The product information may include another piece of information.

Returning to FIG. 2, the provision unit 14 provides, to a user, “product information of a product in which a counterpart shows interest” registered in association with user discrimination information.

For example, the provision unit 14 may browsably display “product information of a product in which a counterpart shows interest” in an information browsing page after logging in to the information providing system 10 via a predetermined application or a web page.

Note that, the information browsing page has a link to a purchase page of each product, and may be configured in such a way as to transition to the purchase page of the product according to a user operation of selecting one piece of product information. The purchase page is a page that accepts an operation for purchasing the product, and displays a product price, a product specification, a product image, a product purchase button, and the like.

In this way, when browsably displaying “product information of a product in which a counterpart shows interest” in an information browsing page after logging in, the provision unit 14 may notify a user, by a push notification of an application, an electronic mail, or the like, that “product information of a product in which a counterpart shows interest” is newly registered.

In addition, the provision unit 14 may notify a user of “product information of a product in which a counterpart shows interest” by an electronic mail. In other words, the product information of the product in which the counterpart shows interest may be indicated in a body or an attached file of an electronic mail.

Moreover, the provision unit 14 may provide a user with a coupon for purchase of a product in which a counterpart shows interest, by a method similar to that described above. The coupon for purchase is a coupon that can be utilized at purchase of the product, and may be, for example, a discount coupon such as “100-yen discount” or “10% discount”, may be a coupon for presenting a free gift, or may be any other coupon.

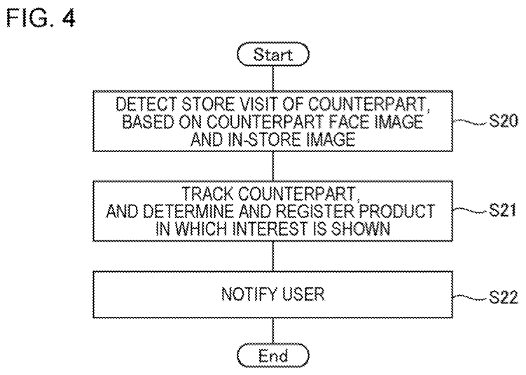

Next, one example of a flow of processing in the information providing system 10 is described by use of a flowchart in FIG. 4.

First, before processing illustrated in FIG. 4 is executed, a user previously performs an operation of registering a counterpart face image in the information providing system 10. In response to the operation, the counterpart face image registration unit 11 acquires a face image (counterpart face image) of a counterpart who is a target of investigation by the user, and registers the counterpart face image in association with user discrimination information of the user.

The information generation unit 12 detects, based on a counterpart face image previously stored in the storage unit 15, a counterpart from an in-store image capturing inside of a store (S20).

Then, when detecting the counterpart, the information generation unit 12 tracks the counterpart within the in-store image. Then, the information generation unit 12 determines, based on a behavior content of the counterpart inside the store, a product in which the counterpart shows interest, and registers product information of the determined product in association with the user discrimination information (S21). The processing of determining a product in which a counterpart shows interest is achieved by use of, for example, at least one of the first to fourth determination methods described above.

Thereafter, the provision unit 14 notifies the user, by a push notification of an application, an electronic mail, or the like, that “product information of a product in which a counterpart shows interest” is newly registered (S22). After logging in to the information providing system 10 at any timing, the user opens an information browsing page, and confirms the “product information of a product in which a counterpart shows interest”.

As another example, the provision unit 14 may notify a user of “product information of a product in which a counterpart shows interest” by an electronic mail. In this case, product information of a product in which the counterpart shows interest is indicated in a body or an attached file of an electronic mail.

### “Advantageous Effect”

The information providing system 10 according to the present example embodiment includes a function of, when detecting a counterpart from an in-store image, based on a counterpart face image registered by a user, determining, based on an in-store behavior of the counterpart indicated in the in-store image, a product in which the counterpart shows interest, and providing a result of the determination to the user. By utilizing the information providing system 10 described above, a user can recognize a product in which a counterpart has interest, in such a way that the counterpart does not notice.

On the other hand, a store that utilizes the information providing system 10 can heighten a purchase rate of a product, by utilizing the information providing system 10 and providing useful information to a user. Moreover, the store can attract, for example, a customer intending to purchase a present.

Moreover, the information providing system 10 can provide a user with a coupon for a product in which a counterpart shows interest. As a result, a store can acquire a benefit such as heightening of a purchase rate of a product and attraction of a customer intending to purchase a present. Moreover, a user can reasonably purchase a product that pleases a counterpart, by utilizing the coupon.

### Second Example Embodiment

An information providing system 10 according to the present example embodiment includes a function of acquiring and registering a counterpart face image without advance registration by a user. The present example embodiment premises that a user and a counterpart (target of investigation) visit a store together. When detecting a user from an in-store image, based on a previously registered face image of the user, the information providing system 10 detects a companion of the detected user from the in-store image. Then, the information providing system 10 cuts out a face image of the companion from the in-store image, and registers the face image as a counterpart face image. Details are described below.

One example of a functional block diagram of the information providing system 10 according to the present example embodiment is illustrated in FIG. 2 similar to the first example embodiment.

A counterpart face image registration unit 11 acquires a face image (hereinafter, “user face image”) of a user input by the user, and registers the user face image in association with user discrimination information of the user. For example, a user performs an operation of logging in to the information providing system 10 (example: input of user discrimination information, or the like) via a predetermined application or a web page. Then, in a user face image registration page after login, the user performs an operation of selecting a user face image stored in a predetermined storage apparatus, and an operation of uploading the selected user face image to the information providing system 10. The user performs the operations via a terminal such as a smartphone, a tablet terminal, a personal computer, a smart watch, or a mobile phone.

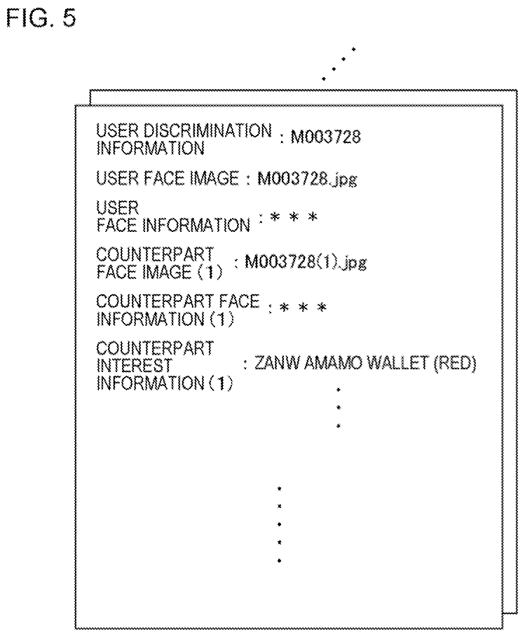

FIG. 5 schematically illustrates one example of information registered by the counterpart face image registration unit 11. The information is stored in a storage unit 15. In the illustrated information, a user face image is registered in association with user discrimination information. In the illustrated information, further, user face information being a feature value of appearance extracted from the user face image is registered in association with the user discrimination information. In this way, the counterpart face image registration unit 11 may extract a feature value of appearance from the user face image, and register the extracted feature value in association with the user discrimination information.

Then, the counterpart face image registration unit 11 detects a user from an in-store image, based on the previously registered user face image. Processing of detecting a user from an in-store image can be achieved by use of any conventional image analysis technique. For example, collation processing of a user face image or a feature value of appearance of a face of a user extracted from the user face image, and an in-store image, or the like is exemplified.

Subsequently, the counterpart face image registration unit 11 detects a companion of the detected user from the in-store image. Then, the counterpart face image registration unit 11 cuts out a face image of the companion from the in-store image, and registers the face image as a counterpart face image (see FIG. 5). Note that, the counterpart face image registration unit 11 may extract a feature value of appearance from the counterpart face image, and register the extracted feature value in association with the user discrimination information (counterpart face information in FIG. 5).

There are various algorithms of determining a companion in an image analysis. For example, the counterpart face image registration unit 11 may determine, to be a companion of a user, a person for whom a state where a distance to the user is equal to or less than a threshold value satisfies a predetermined condition (example: continuing for equal to or more than a predetermined time, a cumulative time is equal to or more than a predetermined time). In addition, the counterpart face image registration unit 11 may determine, to be a companion of a user, a person who has entered a state of staring at the user (a state where lines of sight of each other are facing each other), and a person whose state satisfies a predetermined condition (example: continuing for equal to or more than a predetermined time, a cumulative time is equal to or more than a predetermined time). In addition, the counterpart face image registration unit 11 may determine, to be a companion of a user, a person who has entered a predetermined behavior state such as a state of holding hands with the user, or a state where one person holds a hand around a shoulder or waist of another. Note that, exemplification herein is merely one example, and the present invention is not limited to the content.

Incidentally, there is a case where a user visits a store with a person who is not a target of investigation. Even in such a case, when a face image of a companion is registered as a counterpart face image, and a product in which interest is shown is determined and provided to the user, unnecessary information is provided to the user, and this is not preferable. Thus, in order to avoid the inconvenience, the counterpart face image registration unit 11 may include at least one of avoidance means 1 and 2 below.

—Avoidance Means 1—The counterpart face image registration unit 11 registers in advance, based on a user input, a store visit date to visit a store together with a target of investigation. For example, a user logs in to the information providing system 10 via a predetermined application or a web page, and then performs an operation of inputting a store visit date to visit a store together with a target of investigation, and registering the store visit date in the information providing system 10. The counterpart face image registration unit 11 acquires the store visit date input by the user based on the operation, and registers the store visit date in association with user discrimination information of the user.

Then, the counterpart face image registration unit 11 executes the above-described processing of detecting the user, based on an in-store image captured and generated on the previously registered store visit date, processing of detecting a companion, and processing of cutting out a face image of the companion and registering the face image as a counterpart face image.

### —Avoidance Means 2—

The counterpart face image registration unit 11 registers an attribute of a target of investigation, based on a user input. An attribute to be registered is an attribute being estimable/determinable from an image, and is, for example, gender, an age group, nationality, a physical constitution, height, or the like. For example, a user logs in to the information providing system 10 via a predetermined application or a web page, and then performs an operation of inputting an attribute of a target of investigation, and registering the attribute in the information providing system 10. The counterpart face image registration unit 11 acquires the attribute of a counterpart input by the user based on the operation, and registers the attribute in association with user discrimination information of the user.

Then, the counterpart face image registration unit 11 detects a companion of a user by the above-described processing of detecting the user and processing of detecting the companion, and then estimates and determines an attribute of the detected companion by an image analysis based on an in-store image. Subsequently, the counterpart face image registration unit 11 collates the estimated and determined attribute with the previously registered attribute of the target of investigation. Then, the counterpart face image registration unit 11 cuts out, from the in-store image, a face image of a companion whose estimated attribute matches the attribute of the target of investigation registered in advance, among companions of the user detected from the in-store image, and registers the face image as a counterpart face image.

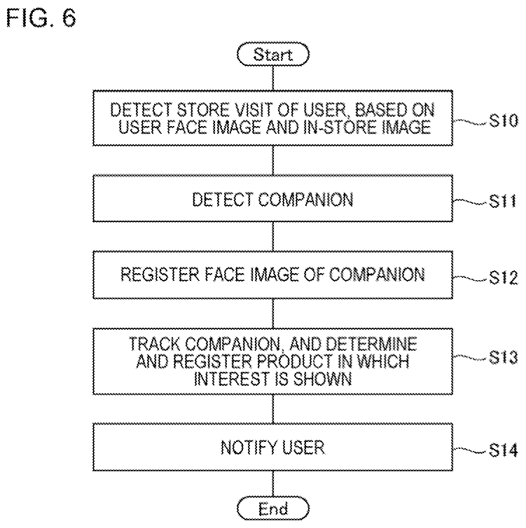

Next, one example of a flow of processing in the information providing system 10 is described by use of a flowchart in FIG. 6.

First, before processing illustrated in FIG. 6 is executed, a user previously performs an operation of registering a user face image in the information providing system 10. In response to the operation, the counterpart face image registration unit 11 acquires a user face image, and registers the user face image in association with user discrimination information of the user.

The counterpart face image registration unit 11 detects, based on a user face image previously stored in the storage unit 15, a user from an in-store image capturing inside of a store (S10). Then, the counterpart face image registration unit 11 detects a companion of the detected user from the in-store image (S11), then cuts out a face image of the companion from the in-store image, and registers the face image as a counterpart face image (S12).

Thereafter, an information generation unit 12 tracks the counterpart (companion) within the in-store image. Then, the information generation unit 12 determines, based on a behavior content of the counterpart inside the store, a product in which the counterpart shows interest, and registers product information of the determined product in association with the user discrimination information (S13). The processing of determining a product in which a counterpart shows interest is achieved by use of, for example, at least one of the first to fourth determination methods described in the first example embodiment.

Thereafter, a provision unit 14 notifies the user, by a push notification of an application, an electronic mail, or the like, that “product information of a product in which a counterpart shows interest” is newly registered (S14). After logging in to the information providing system at any timing, the user opens an information browsing page, and confirms the “product information of a product in which a counterpart shows interest”.

As another example, the provision unit 14 may notify a user of “product information of a product in which a counterpart shows interest” by an electronic mail. In this case, product information of a product in which the counterpart shows interest is indicated in a body or an attached file of an electronic mail.

Other components of the information providing system 10 are similar to those according to the first example embodiment.

The information providing system 10 according to the present example embodiment achieves an advantageous effect similar to that according to the first example embodiment. Moreover, with the information providing system 10 according to the present example embodiment, a user may register his/her own face image in advance, and does not need to register a face image of a counterpart. Thus, difficulty of work to be performed by a user becomes low.

### Modified Example

Herein, a modified example of the information providing system 10 according to the present example embodiment is described. Depending on an algorithm or the like of determining a companion, it requires a certain time from store visit of a counterpart who is a target of investigation to registration of a face image of the counterpart in the information providing system 10 as a counterpart face image. Then, when processing of determining, based on a behavior content of a counterpart inside a store, a product in which the counterpart shows interest is started after a counterpart face image is registered, processing of determining a product in which the counterpart shows interest is not executed in a time period from store visit of the counterpart who is a target of investigation to registration of a face image of the counterpart in the information providing system 10 as a counterpart face image. As a result, a behavior content of the counterpart in a time from store visit of the counterpart who is a target of investigation to registration of a face image of the counterpart in the information providing system 10 is not reflected in information (product information of a product in which the counterpart shows interest) provided to a user. In order to avoid the inconvenience, the following modified example may be adopted.

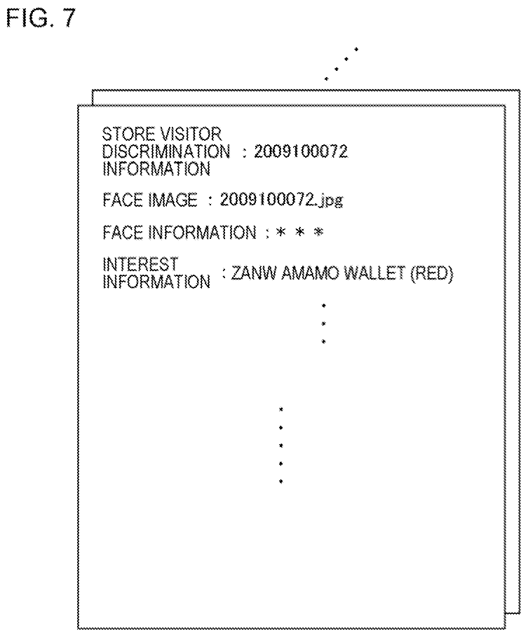

The information generation unit 12 assigns store visitor discrimination information to each of all store visitors detected from an in-store image, and manages the store visitor discrimination information by associating, therewith, a face image of each store visitor cut out from the in-store image and a feature value of appearance extracted from the face image (see FIG. 7). Then, the information generation unit 12 executes processing of determining, based on the above-described in-store behavior, a product in which interest is shown, for each of all the store visitors detected from the in-store image, and registers product information of the determined product in association with store visitor discrimination information of each of the store visitors (see FIG. 7).

Then, when the counterpart face image registration unit 11 determines a certain store visitor as a companion of a certain user, and a face image of the certain store visitor is registered as a counterpart face image in association with user discrimination information of the certain user, the information generation unit 12 registers product information (see FIG. 7) of a product in which the store visitor registered so far shows interest, in association with user discrimination information of the user.

According to the modified example, a product in which a counterpart shows interest when visiting a store can be detected without fail, and provided to a user. Moreover, a store can recognize a product in which each of all store visitors shows interest. Then, changing of lineup of products or the like can be performed by utilizing the information.

### Third Example Embodiment

An information providing system 10 according to the present example embodiment includes a function of estimating a relationship between a user and a counterpart, and providing useful information to the user, based on a result of the estimation. Details are described below.

One example of a functional block diagram of the information providing system 10 according to the present example embodiment is illustrated in FIG. 2 similar to the first and second example embodiments.

An information generation unit 12 according to the present example embodiment estimates an attribute of a counterpart, based on at least one of a counterpart face image and an in-store image. Then, the information generation unit 12 estimates a relationship between a user and the counterpart, based on the estimated attribute of the counterpart and an attribute of the user. The attribute of the user may be previously registered in the information providing system 10 by the user himself/herself, or may be estimated based on at least one of a user face image and an in-store image. An attribute is estimable from an image, and is gender, an age group, or the like.

For example, when a user and a counterpart are different in gender from each other, and are close in age group (the same age group, or a difference therebetween is equal to or less than a threshold value), the information generation unit 12 may estimate that a relationship between the user and the counterpart is a couple. Moreover, when a user and a counterpart are of the same gender and close in age group (the same age group, or a difference therebetween is equal to or less than a threshold value), the information generation unit 12 may estimate that a relationship between the user and the counterpart is a friend. Moreover, when age groups of a user and a counterpart are far (a difference therebetween is larger than a threshold value), the information generation unit 12 may estimate that a relationship between the user and the counterpart is a parent and a child.

Moreover, the information generation unit 12 may estimate a relationship between a user and a counterpart in consideration of a seasonal situation at the time. For example, in a predetermined period before an event such as Valentine's Day or Christmas, the threshold value of a difference in age group for estimating as a couple may be made larger than in another period (it becomes easier to determine as a couple).

A provision unit 14 provides a user with, as related information, not only product information of a product in which a counterpart shows interest, but also, in a combination of another user and another counterpart matching a relationship between the user and the counterpart, product information of a product in which the another counterpart shows interest.

In other words, the provision unit 14 determines a combination of the another user and the another counterpart matching the relationship between the user and the counterpart, based on the above-described estimation result of the relationship by the information generation unit 12. Then, the provision unit 14 provides the user with, as related information, product information, registered in association with user discrimination information of the determined another user, of a product in which the counterpart shows interest.

Other components of the information providing system 10 are similar to those according to the first and second example embodiments.

The information providing system 10 according to the present example embodiment achieves an advantageous effect similar to that according to the first and second example embodiments. Moreover, the information providing system 10 according to the present example embodiment can provide a user with, as related information, information relating to another user and another counterpart matching a relationship between the user and a counterpart, specifically, product information of a product in which the another counterpart shows interest. The user can select a product to be presented to the counterpart, based on such related information.

Moreover, with the information providing system 10 according to the present example embodiment, a store can recognize what relationship a person utilizing the store for present selection has, what product the person shows interest in, and the like. Changing of lineup of products or the like can be performed by utilizing the information.

While the example embodiments of the present invention have been described above with reference to the drawings, the example embodiments are exemplifications of the present invention, and various configurations other than the above can also be adopted.

Note that, in the present description, “acquisition” includes at least one of “fetching, by a local apparatus, data stored in another apparatus or a storage medium (active acquisition)”, for example, receiving by requesting or inquiring of the another apparatus, accessing the another apparatus or the storage medium and reading, and the like, based on a user input, or based on an instruction of a program, “inputting, into a local apparatus, data output from another apparatus (passive acquisition)”, for example, receiving data given by distribution (or transmission, push notification, or the like), selecting and acquiring from received data or information, based on a user input, or based on an instruction of a program, and “generating new data by editing of data (conversion into text, rearrangement of data, extraction of partial data, changing of a file format, or the like) or the like, and acquiring the new data”.

Moreover, although a plurality of processes (pieces of processing) are described in order in a plurality of flowcharts used in the above description, an execution order of processes executed in each example embodiment is not limited to the described order. In each example embodiment, an order of illustrated processes can be changed to an extent that causes no problem in terms of content. Moreover, each example embodiment described above can be combined to an extent that content does not contradict.

Some or all of the above-described example embodiments can also be described as, but are not limited to, the following supplementary notes.
1. An information providing system including:
   a counterpart face image registration unit that acquires a counterpart face image being a face image of a counterpart who is a target of investigation by a user, and registers the counterpart face image in association with user discrimination information of the user;
   an information generation unit that detects, based on the counterpart face image, the counterpart from an in-store image capturing inside of a store, determines, based on a behavior content of the detected counterpart inside a store indicated in the in-store image, a product in which the counterpart shows interest, and registers product information of the determined product in association with the user discrimination information; and
   a provision unit that provides the user with product information, registered in association with the user discrimination information, of a product in which the counterpart shows interest.
2. The information providing system according to supplementary note 1, wherein
   the counterpart face image registration unit
      detects the user from the in-store image, based on a previously registered face image of the user,
      detects a companion of the detected user from the in-store image, and
      cuts out a face image of the companion from the in-store image, and registers the face image as the counterpart face image.
3. The information providing system according to supplementary note 2, wherein
   the counterpart face image registration unit
      registers in advance, based on a user input, a store visit date to visit a store together with the companion, and
      executes processing of detecting the user, based on the in-store image generated on the previously registered store visit date, processing of detecting the companion, and processing of cutting out a face image of the companion and registering the face image as the counterpart face image.
4. The information providing system according to supplementary note 2 or 3, wherein
   the counterpart face image registration unit
      registers an attribute of the counterpart, based on a user input, and
      cuts out, from the in-store image, a face image of the companion whose attribute estimated from the in-store image matches a registered attribute of the companion, among the companions detected from the in-store image, and registers the face image as the counterpart face image.
The information providing system according to supplementary note 1, wherein
the counterpart face image registration unit
   acquires and registers the counterpart face image input by the user.
6. The information providing system according to any one of supplementary notes 1 to 5, wherein
   the information generation unit
      estimates an attribute of the counterpart, based on at least one of the counterpart face image and the in-store image, and estimates a relationship between the user and the counterpart, based on the estimated attribute of the counterpart.
7. The information providing system according to supplementary note 6, wherein
   the provision unit
      determines a combination of the another user and the another counterpart matching the relationship between the user and the counterpart, and
      provides the user with, as related information, product information, registered in association with user discrimination information of the determined another user, of a product in which the counterpart shows interest.
8. The information providing system according to any one of supplementary notes 1 to 7, wherein
   the provision unit
      provides the user with a coupon for purchase of a product in which the counterpart shows interest.
9. An information providing method including,
   by a computer:
      acquiring a counterpart face image being a face image of a counterpart who is a target of investigation by a user, and registering the counterpart face image in association with user discrimination information of the user;
      detecting, based on the counterpart face image, the counterpart from an in-store image capturing inside of a store, determining, based on a behavior content of the detected counterpart inside a store indicated in the in-store image, a product in which the counterpart shows interest, and registering product information of the determined product in association with the user discrimination information; and
      providing the user with product information, registered in association with the user discrimination information, of a product in which the counterpart shows interest.
10. A program causing a computer to function as:
   a counterpart face image registration unit that acquires a counterpart face image being a face image of a counterpart who is a target of investigation by a user, and registers the counterpart face image in association with user discrimination information of the user,
   an information generation unit that detects, based on the counterpart face image, the counterpart from an in-store image capturing inside of a store, determines, based on a behavior content of the detected counterpart inside a store indicated in the in-store image, a product in which the counterpart shows interest, and registers product information of the determined product in association with the user discrimination information, and
   a provision unit that provides the user with product information, registered in association with the user discrimination information, of a product in which the counterpart shows interest.

This application is based upon and claims the benefit of priority from Japanese patent application No. 2020-173969, filed on Oct. 15, 2020, the disclosure of which is incorporated herein in its entirety by reference.

### REFERENCE SIGNS LIST

10 Information providing system
11 Counterpart face image registration unit
12 Information generation unit
14 Provision unit
15 Storage unit
1A Processor
2A Memory
3A Input/output I/F
4A Peripheral circuit
5A Bus

What is claimed is:

1. An information providing system comprising:
at least one memory configured to store one or more instructions; and
at least one processor configured to execute the one or more instructions to:
acquire a counterpart face image being a face image of a counterpart who is a target of investigation by a user, and register the counterpart face image in association with user discrimination information of the user;
detect, based on the counterpart face image, the counterpart from an in-store image capturing inside of a store, determine, based on a behavior content of the detected counterpart inside a store indicated in the in-store image, a product in which the counterpart shows interest, and register product information of the determined product in association with the user discrimination information; and
provide the user with product information, registered in association with the user discrimination information, of a product in which the counterpart shows interest.

2. The information providing system according to claim 1, wherein
the processor is further configured to execute the one or more instructions to
detect the user from the in-store image, based on a previously registered face image of the user,
detect a companion of the detected user from the in-store image, and
cut out a face image of the companion from the in-store image, and register the face image as the counterpart face image.

3. The information providing system according to claim 2, wherein
the processor is further configured to execute the one or more instructions to
register in advance, based on a user input, a store visit date to visit a store together with the companion, and
execute processing of detecting the user, based on the in-store image generated on the previously registered store visit date, processing of detecting the companion, and processing of cutting out a face image of the companion and registering the face image as the counterpart face image.

4. The information providing system according to claim 2, wherein the processor is further configured to execute the one or more instructions to
register an attribute of the counterpart, based on a user input, and
cut out, from the in-store image, a face image of the companion whose attribute estimated from the in-store image matches a registered attribute of the companion, among the companions detected from the in-store image, and register the face image as the counterpart face image.

5. The information providing system according to claim 1, wherein the processor is further configured to execute the one or more instructions to
acquire and register the counterpart face image input by the user.

6. The information providing system according to claim 1, wherein
the processor is further configured to execute the one or more instructions to
estimate an attribute of the counterpart, based on at least one of the counterpart face image and the in-store image, and estimate a relationship between the user and the counterpart, based on the estimated attribute of the counterpart.

7. The information providing system according to claim 6, wherein the processor is further configured to execute the one or more instructions to
determine a combination of the another user and the another counterpart matching the relationship between the user and the counterpart, and
provide the user with, as related information, product information, registered in association with user discrimination information of the determined another user, of a product in which the counterpart shows interest.

8. The information providing system according to claim 1, wherein
the processor is further configured to execute the one or more instructions to
provide the user with a coupon for purchase of a product in which the counterpart shows interest.

9. An information providing method comprising,
by a computer:
acquiring a counterpart face image being a face image of a counterpart who is a target of investigation by a user, and registering the counterpart face image in association with user discrimination information of the user;
detecting, based on the counterpart face image, the counterpart from an in-store image capturing inside of a store, determining, based on a behavior content of the detected counterpart inside a store indicated in the in-store image, a product in which the counterpart shows interest, and registering product information of the determined product in association with the user discrimination information; and
providing the user with product information, registered in association with the user discrimination information, of a product in which the counterpart shows interest.

10. A non-transitory storage medium storing a program causing a computer to:
acquire a counterpart face image being a face image of a counterpart who is a target of investigation by a user, and register the counterpart face image in association with user discrimination information of the user,
detect, based on the counterpart face image, the counterpart from an in-store image capturing inside of a store, determine, based on a behavior content of the detected counterpart inside a store indicated in the in-store image, a product in which the counterpart shows interest, and register product information of the determined product in association with the user discrimination information, and
provide the user with product information, registered in association with the user discrimination information, of a product in which the counterpart shows interest.
